(19) United States
(12) Patent Application Publication
(10) Pub. No.: US 2022/0076107 A1
(43) Pub. Date: Mar. 10, 2022

(54) NEURAL NETWORK PROCESSING DEVICE, DATA PROCESSING METHOD AND DEVICE

(71) Applicant: Sigmastar Technology, Ltd., Xia'men City (CN)

(72) Inventors: Xiao-Feng Li, Xiamen (CN); Cheng-Wei Zheng, Xiamen (CN); Bo Lin, Xiamen (CN)

(21) Appl. No.: 17/391,268

(22) Filed: Aug. 2, 2021

(30) Foreign Application Priority Data
Sep. 9, 2020 (CN) 202010942302.6

(51) Int. Cl. G06N 3/063

(52) U.S. Cl. CPC G06N 3/063

(57) ABSTRACT

A neural network processing device includes first and second operators. The first operator performs a specific calculation on input data to generate first output data. The second operator performs a function calculation on the first output data. The second operator includes a front-end processing circuit, a lookup table circuit, an interpolator circuit, and a back-end processing circuit. The front-end processing circuit performs a first data processing on the first output data to generate processed data. The lookup table circuit searches a first lookup table according to the processed data to obtain lookup data. The first lookup table includes mapping information between first independent variables and first dependent variables corresponding to the function calculation. The interpolator circuit performs an interpolation on the lookup data to obtain interpolated data. The back-end processing circuit performs a second data processing on the interpolated data to generate second output data.

### BACKGROUND

### 1. Technical Field

The present disclosure relates to a field of electronic apparatus technology. More particularly, the present disclosure relates to a neural network processing device and data processing method and device applied to a neural network processing device.

### 2. Description of Related Art

Currently, deep neural networks have achieved great success in various aspects (which include, for example, image classification, object detection, image segmentation) in the computer field. However, deep neural networks with better performance often have a huge number of model parameters, which not only require large amount of calculation but also occupy a large space in actual configuration. As a result, such networks cannot be applied properly in certain scenarios that require real-time calculations.

When a neural network processing device performs data processing, it often involves the data calculation of non-linear functions. For example, common nonlinear functions include logarithmic functions. However, in related approaches, based on a graph of the logarithmic function, a slope of the logarithmic function varies greatly over a certain range within the domain of the logarithmic function, which results in a large amount of calculation of the logarithmic function and the difficulty of obtaining high-precision calculation results. As a result, these approaches cannot meet the requirements of application scenarios that require real-time calculations.

### SUMMARY

Some embodiments of the present disclosure provide a neural network processing device and a data processing method and device applied to a neural network device to efficiently and precisely implement calculations of non-linear and/or complicated function(s) in the neural network.

In a first aspect, some embodiments provide a neural network processing device that includes a first operator and a second operator. The first operator is configured to perform a specific calculation on input data to generate first output data. The second operator is configured to perform a function calculation on the first output data. The second operator includes a front-end processing circuit, a lookup table circuit, an interpolator circuit, and a back-end processing circuit. The front-end processing circuit is configured to perform a first data processing on the first output data to generate processed data. The lookup table circuit is configured to search a first lookup table according to the processed data to obtain lookup data, in which the first lookup table comprises mapping information between a plurality of first independent variables and a plurality of first dependent variables corresponding to the function calculation. The interpolator circuit is configured to perform an interpolation on the lookup data to obtain interpolated data. The back-end processing circuit is configured to perform a second data processing on the interpolated data to generate second output data.

In a second aspect, some embodiments provide a data processing method that is applied to an operator of a neural network processing device. The operator is configured to perform a function calculation, and the data processing method includes the following operations: performing a first data processing on input data to generate processed data; searching a first lookup table according to the processed data to obtain lookup data, in which the first lookup table includes mapping information between a plurality of first independent variables and a plurality of first dependent variables corresponding to the function calculation; performing an interpolation on the lookup data to generate interpolated data; and performing a second data processing on the interpolated data to generate output data.

In a second aspect, some embodiments provide a data processing device that is applied to an operator of a neural network processing device. The operator is configured to perform a function calculation, and the data processing device includes a front-end processing circuit, a lookup table circuit, an interpolator circuit, and a back-end processing circuit. The front-end processing circuit is configured to perform a first data processing on input data to generate processed data. The lookup table circuit is configured to search a first lookup table according to the processed data to obtain lookup data, in which the first lookup table includes mapping information between a plurality of first independent variables and a plurality of first dependent variables corresponding to the function. The interpolator circuit is configured to perform an interpolation on the lookup data to obtain interpolated data. The back-end processing circuit is configured to perform a second data processing on the interpolated data to generate output data.

In some embodiments, a data processing device having a lookup table function is employed to implement operator(s) of the neural network processing device, in order to efficiently and precisely implement non-linear and/or complicated function(s) in the neural network.

### BRIEF DESCRIPTION OF THE DRAWINGS

FIG. 1 is a block diagram of a neural network processing device according to some embodiments of the present disclosure.

FIG. 2 is a block diagram of a data processor device according to some embodiments of the present disclosure.

FIG. 3. is a flow chart of a data processing method according to some embodiments of the present disclosure.

FIG. 4 is a schematic diagram of the first lookup table according to some embodiments of the present disclosure.

FIG. 5 is a schematic diagram of the second lookup table according to some embodiments of the present disclosure.

FIG. 6 is a graph of a natural logarithm function according to some embodiments of the present disclosure.

FIG. 7 is a graph of a natural logarithm function over an interval [0.5, 1] according to some embodiments of the present disclosure.

### DETAILED DESCRIPTION

Reference is made to various figures, in which like elements are designated with the same reference numbers. For illustrative purposes, the principle of the present disclosure is illustrated with a proper application environment. The following illustrations are given based on particular embodiments, and are not intended as a limitation on various modifications and/or arrangements based on embodiments of the present disclosure.

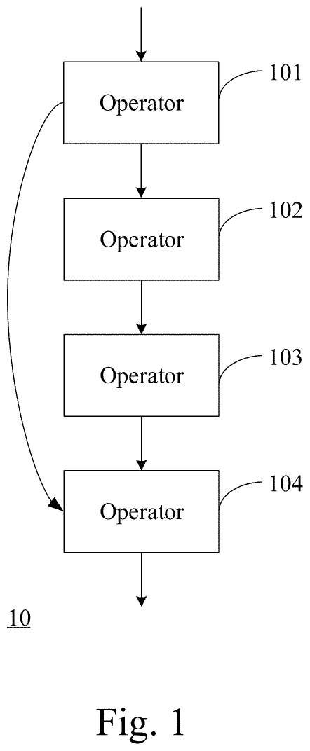

Some embodiments of the present disclosure provide a neural network processing device that is capable of reducing the amount of computation and increasing the precision of calculation. Reference is made to FIG. 1, and FIG. 1 is a block diagram of a neural network processing device according to some embodiments of the present disclosure. A neural network processing device 10 may be applied in scenarios including image recognition, data analysis, and so on, and may be applied in an electronic apparatus including, for example, a smart phone or a security system. The neural network processing device 10 includes an operator 101, an operator 102, an operator 103, and an operator 104. Each operator is configured to perform a specific calculation. For example, the operator 101 is a convolution operator configured to perform a convolution calculation. The operator 102 is an exponential operator configured to perform an exponential function calculation. The operator 103 is a natural logarithm operator configured to perform a natural logarithm function calculation. The operator 104 is a multiplication operator configured to perform a multiplication calculation. In some embodiments, connections among various operators in the neural network processing device 10 are predetermined, and parameters of each operator may be set through a training progress of the neural network. For example, weights parameter(s) and bias parameter(s) in the operator 101 may be set by the training progress of the neural network.

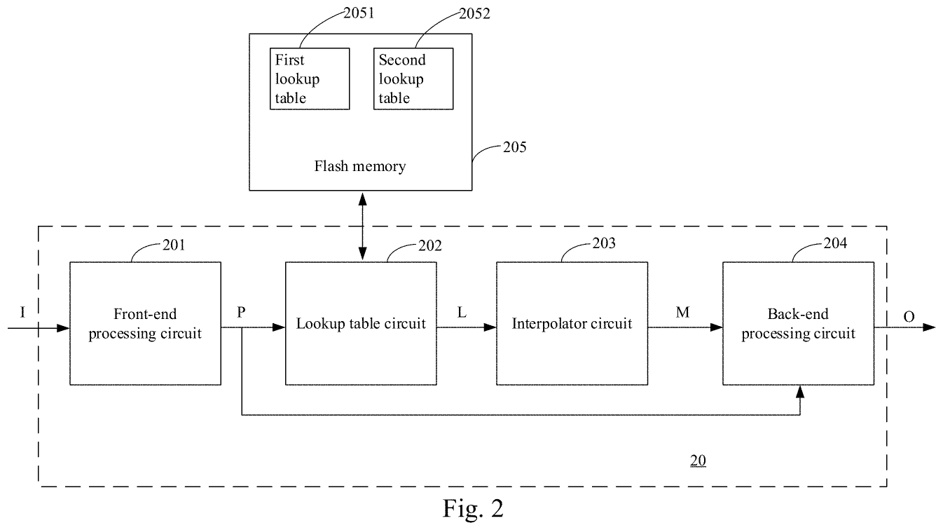

In some embodiments of the present disclosure, a data processing device having a lookup table function is utilized to implement operators of the neural network processing device to efficiently and precisely implement calculations of non-linear and/or complicated function(s) (which may include, for example, an exponential function, a hyperbolic tangent function, a logarithmic function, and so on.) in the neural network. Reference is made to FIG. 2, and FIG. 2 is a block diagram of a data processor device according to some embodiments of the present disclosure. A data processing device 20 includes a front-end processing circuit 201, a lookup table circuit 202, an interpolator circuit 203, and a back-end processing circuit 204. The data processing device 20 may be applied to the neural network processing device 10. Specifically, the data processing device 20 may be utilized to implement the exponential function of the operator 102 and the logarithmic function of the operator 103.

In some embodiments, the data processing device 20 may access lookup table(s) in a flash memory 205 to perform a natural logarithm function calculation. As shown in FIG. 2, in this embodiment, the flash memory 205 stores two lookup tables which are a first lookup table 2051 and a second lookup table 2052 respectively. The first lookup table 2051 stores values of independent variables and values of dependent variables respectively corresponding to the independent variables of the natural logarithm function. In other words, the first lookup table 2051 stores mapping information about the independent variables and the dependent variables. The second lookup table 252 stores values of independent variables and values of dependent variables respectively corresponding to the independent variables of the logarithm function. The first lookup table 2051 is different from the second lookup table 2052. In some embodiments, the independent variables in the first lookup table 2051 and the second lookup table 2052 are within a predetermined numerical interval, and a curvature of a graph of the natural logarithm function over the predetermined numerical interval is smaller than a predetermined threshold. It indicates that the graph of the natural logarithm function over the predetermined value interval is approximate to be a linear graph. In this embodiment, the natural logarithm function of the operator 103 may be implemented with two lookup tables in the flash memory 205. However, in other embodiments, a specific function may be implemented with one lookup table or three lookup tables.

In this embodiment, the independent variables in the first lookup table 2501 are greater than or equal to a first value a and is smaller than or equal to a second value b, and the independent variables in the second lookup table 2052 are greater than or equal to the first value a and is smaller than or equal to a third value c, in which the second value b is smaller than the third value c. In other words, the independent variables in the first lookup table 2051 are within an interval [a, b], and the independent variables in the second lookup table 2052 are within an interval [a, c]. In this embodiment, a, b, and c are all within the predetermined numerical interval.

Furthermore, in this embodiment, the difference value between any two adjacent independent variables in the first lookup table 2051 is a first difference value, the difference value between any two adjacent independent variables in the second lookup table 2052 is a second difference value, and the first difference value is smaller than the second difference value. In other words, a gap among the independent variables in the first lookup table 2051 is less than a gap among the independent variables in the second lookup table 2052, such that the precision of the function calculation performed with the first lookup table 2051 is higher than the precision of the function calculation performed with the second lookup table 2052.

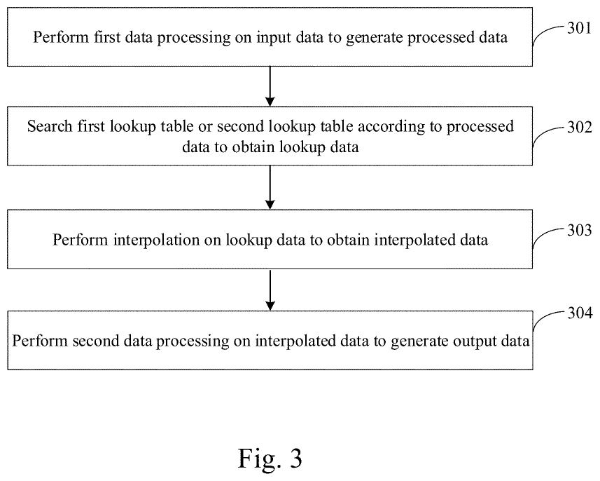

Reference is made to FIG. 3. FIG. 3. is a flow chart of a data processing method according to some embodiments of the present disclosure. The data processing method may be applied to the neural network processing device 10, and can be implemented with the data processing device 20. Operations of the data processing device 20 and the corresponding data processing method will be described in the following paragraphs with reference to examples that implement the logarithm function of the operator 103.

The flow chart of the data processing method in some embodiments of the present disclosure may include the following steps.

In step 301, the front-end processing circuit 201 performs a first data processing on input data, in order to generate processed data. In this embodiment, an input data I of the front-end processing circuit 201 is output data of the operator 102. The front-end processing circuit 201 performs the first data processing on the input data I according to internal requirements of the data processing device 20. The first data processing may include performing a numerical format conversion on the input data I. For example, the input data I is converted from a fixed-point number format to another fixed-point number format, or the input data I is converted from a fixed-point number format to a floating-point number format. With the numerical format conversion, the numerical format of the processed data P meets the requirements of internal operations of the data processing device 20. In some implementations, the front-end processing circuit 201 may be implemented by utilizing a hardware device having shifting circuit(s) or a processor that executes program code(s).

This embodiment is illustrated with an example where the natural logarithm function is Y=ln(X). In some other embodiments, the logarithm function may be other logarithm function in which the base is a positive number other than 1 (for example, the other logarithm function may be a common logarithm function with base 10). In one specific embodiment, the first value a is 0.5, the second value b is 0.5625, and the third value c is 1. That is, the independent variables in the first lookup table 2051 are within an interval [0.5, 0.5625], and the independent variables in the second lookup table 2052 are within an interval [0.5, 1].

In some embodiments, when the input data I is not within the searching ranges of the first lookup table 2051 and the second lookup table 2052, the first data processing performed by the front-end processing circuit 201 on the input data I may include performing a numerical equivalent conversion on the input data I, such that the processed data P include a first portion value and a second portion value. The first portion value is within the searching range of the first lookup table 2051 and/or the second lookup table 2052. The lookup circuit 202 may search the first lookup table 2051 or the second lookup table 2052 according to the first portion value.

As mentioned in the above specific embodiment, if the input data I is 2.2, the value of ln (2.2) is to be calculated. As 2.2 is greater than the third value 1, the front-end processing circuit 201 may perform the numerical equivalent conversion on the input data I to determine the first portion value and the second portion value. In this embodiment, a multiplication of the first portion value and the second portion value is equal to the input data I. The first portion value is greater than or equal to the first value a and is smaller than or equal to the third value c. The second portion value is a predetermined positive integer to the power of n, and the predetermined positive integer is not 1. For example, the predetermined positive integer may be 2. In some other embodiments, the predetermined positive integer may be other positive integer other than 1 (which may be, for example, 3 or 5). Therefore, when the input data I is 2.2, it may be converted to be 0.55×2² (i.e., 2.2=0.55×2²). In this case, the first portion value is 0.55, and the second portion value is 2². Based on these values, ln (2.2)=ln (0.55×2²)=ln (0.55)+ln (2²)=ln (0.55)+2×ln (2).

In step 302, the first lookup table or the second lookup table is searched according to the processed data to obtain lookup data. The lookup table circuit 202 may selectively search one of the first lookup table 2051 and the second lookup table 2052 according to the processed data P.

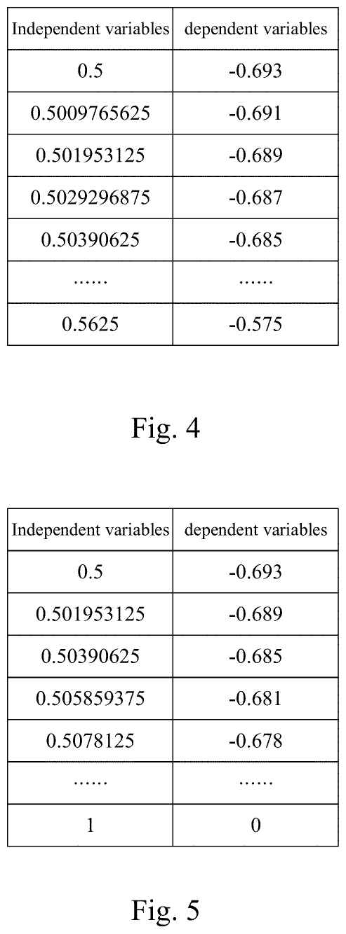

FIG. 4 is a schematic diagram of the first lookup table 2051 according to some embodiments of the present disclosure. The independent variables are within the interval [0.5, 0.5625]. The first lookup table 2051 includes 65 independent variables that are listed in ascending order, and a difference value between any two adjacent independent variables is 0.0009765625. In some other embodiments, the independent variables in the first lookup table 2051 may be within an interval [0.55, 0.8] or an interval [0.5, 0.55], and the present disclosure is not limited thereto.

FIG. 5 is a schematic diagram of the second lookup table 2052 according to some embodiments of the present disclosure. The independent variables of the second lookup table 2052 are within an interval [0.5, 1]. The second lookup table 2052 includes 257 independent variables that are listed in ascending order. A difference value between any two adjacent independent variables is 0.001953125. Similarly, in some other embodiments, the independent variables of the second lookup table 2052 may be within a different interval.

As mentioned in the above specific embodiments, when the first portion value of the processed data P is 0.55, as the precision of the first lookup table 2051 is higher than that of the second lookup table 2052, the lookup table circuit 202 may search the first lookup table 2051 to obtain a corresponding lookup data L. As a value of a 52nd independent variable of the first lookup table 2051 is 0.5498046875, a value of a 53rd independent variable of the first lookup table 2051 is 0.55078125, and 0.5498046875<0.55<0.55078125. The lookup table circuit 202 may obtain the lookup data L according to dependent variables corresponding to the 52nd and the 53rd independent variables in the first lookup table 2051.

When the first portion value in the processed data P is 0.8, the lookup table circuit 202 may search the second lookup table 2052 to obtain the corresponding lookup table L. As the value of the 154th independent variable in the second lookup table 2052 is 0.798828125, the value of the 155th independent variable in the first lookup table 2051 is 0.80078125, and 0.798828125<0.8<0.80078125. The lookup table circuit 202 may obtain the lookup data L according to the dependent variables corresponding to the 154th and 155th independent variables in the second lookup table 2052.

In step 303, an interpolation is performed on the lookup data to obtain interpolated data. The interpolator circuit 203 performs a linear interpolation on the lookup data L to obtain interpolated data M.

As mentioned in the above specific embodiment, when the first portion value in the processed data P is 0.55, the interpolator circuit 203 performs the linear interpolation on dependent variables corresponding to the 52-th and 53-th independent variables in the first lookup table 2051 to derive that ln(0.55)=(−0.5976).

Similarly, when the first portion value in the processed data P is 0.8, the interpolator circuit 203 performs the linear interpolation on dependent variables corresponding to the 154-th and 155-th independent variables in the second lookup table 2052 to derive that ln(0.8)=(−0.2232).

In step 304, a second data processing is performed on the interpolated data to generate output data. In greater detail, the back-end processing circuit 204 may perform the second data processing on the interpolated data M according to data format required by back-end operator(s) and/or further calculation requirement(s) for the interpolated data M, in order to generate output data O.

In an embodiment, the second data processing may include performing numerical format conversion on the interpolated data M. For example, the interpolated data M is converted from a format of fixed-point number to another format of fixed-point number, or the interpolated data M is converted from a format of fixed-point number to a format of floating-point number. With the numerical format conversion, the numerical format of the interpolated data M may meet requirements of subsequent operators of the data processing device 20. In some embodiments, the back-end processing circuit 204 may be implemented with a hardware device including shifting circuit(s), or may be implemented with a processor that executes program code(s).

In addition, the second data processing performed by the back-end processing unit 204 includes performing a calculation on the interpolated data M according to the second portion value in the processed data P. As mentioned in the above specific embodiment, if the input data I is 2.2, it can be converted to be 0.55×2² (i.e., 2.2=0.55×2²). On this condition, the first portion value is 0.55, and the second portion value is 2². Based on this, ln (2.2)=ln (0.55×2²)=ln (0.55)+ln (2²)=ln (0.55)+2×ln(2). The value of ln (2) may be predetermined and stored in advance. For example, ln (2)=0.693. The interpolated data M of ln (0.55) is (−0.5976). Accordingly, ln (2.2)=ln (0.55)+2×ln(2)=(−0.5976)+2×(0.693)=0.7884. In other words, in this example, the output data O is 0.7884.

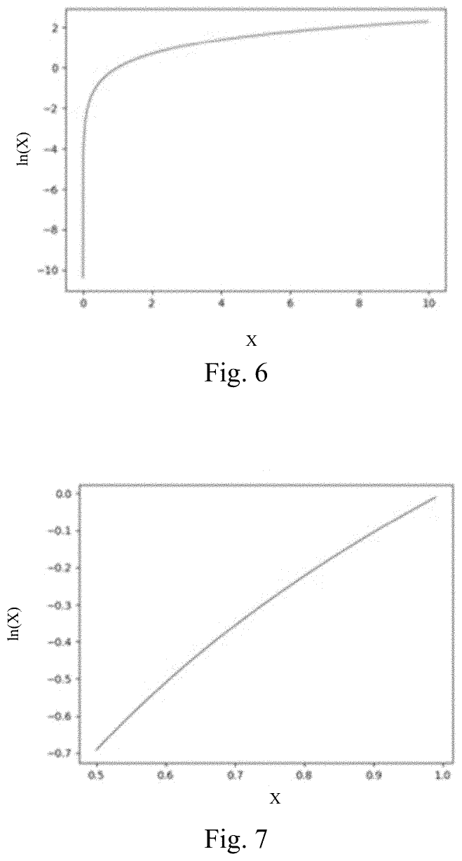

In is noted that, as shown in FIG. 6, based on the graph of the logarithmic function, the range of the logarithmic function is very wide, and the logarithmic function has a slope that changes greatly near the domain 0, which is not suitable to determine the value of the logarithmic function by directly utilizing the lookup table(s) and linear interpolation, otherwise, the precision of the calculation result of the function would be low.

In an embodiment, as independent variables of the first lookup table 2051 and the second lookup table 2052 are within the numerical interval [0.5, 1], when the logarithmic function is determined, the independent variables that are inputted to the logarithmic function may be converted to be within the numerical interval [0.5, 1]. For example, for an input independent variable r higher than 1, r=s×2^{k}, ln(r)=ln(s×2^{k})=ln(s)+ln(2k)=ln(s)+k×ln(2), in which s is within the numerical interval [0.5, 1] (i.e., the value of S is between 0.5 and 1). As the graph of the natural logarithm function over the numerical interval [0.5, 1] is approximate to a straight line, as shown in FIG. 7, ln(s) may be determined with linear interpolation by using the first lookup table 2051 and the second lookup table 2052, and a high-precision calculation result can be obtained. Moreover, the precise values of k and ln (2) can be obtained as well. Therefore, the final value of ln(r) with higher precision can be obtained.

It can be understood that the above implementations are merely intended to illustrate the principles of the neural network device and data processing method and device applied to the neural network device provided in embodiments of the present disclosure by way of examples, rather than to limit the scope of the present disclosure. For people having ordinary skill in the art, various modifications and improvements can be made without departing from the spirit and essence of the present disclosure, and these modifications and improvements are also regarded as the scope of the present disclosure.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

What is claimed is:

1. A neural network processing device, comprising:
a first operator configured to perform a specific calculation on input data to generate first output data; and
a second operator configured to perform a function calculation on the first output data, wherein the second operator comprises:
a front-end processing circuit configured to perform a first data processing on the first output data to generate processed data;
a lookup table circuit configured to search a first lookup table according to the processed data to obtain lookup data, wherein the first lookup table comprises mapping information between a plurality of first independent variables and a plurality of first dependent variables corresponding to the function calculation;
an interpolator circuit configured to perform an interpolation on the lookup data to obtain interpolated data; and
a back-end processing circuit configured to perform a second data processing on the interpolated data to generate second output data.

2. The neural network processing device of claim 1, wherein the first lookup table is stored in a flash memory, the flash memory further stores a second lookup table, the second lookup table comprises mapping information between a plurality of second independent variables and a plurality of second dependent variables corresponding to the function calculation, a gap among the first independent variables is smaller than a gap among the second independent variables, and the lookup table circuit selectively searches one of the first lookup table and the second lookup table according to the processed data to obtain the lookup data.

3. The neural network processing device of claim 1, wherein the first lookup table is stored in a flash memory, the flash memory further stores a second lookup table, the second lookup table comprises mapping information between a plurality of second independent variables and a plurality of second dependent variables corresponding to the function calculation, the first independent variables are within a first numerical interval, the second independent variables are within a second numerical interval, the first numerical interval is different from the second numerical interval, and the lookup table circuit selectively searches one of the first lookup table and the second lookup table according to the processed data to obtain the lookup data.

4. The neural network processing device of claim 1, wherein the first data processing comprises performing a numerical format conversion on the first output data.

5. The neural network processing device of claim 1, wherein the first data processing comprises performing a numerical equivalent conversion on the first output data to obtain a first portion value and a second portion value, and the processed data comprises the first portion value and the second portion value.

6. The neural network processing device of claim 5, wherein the lookup table circuit searches the first lookup table according to the first portion value of the processed data, and the back-end processing circuit performs the second data processing on the interpolated data according to the second portion value of the processed data.

7. The neural network processing device of claim 5, wherein the first portion value obtained through the numerical equivalent conversion is within a searching range of the first lookup table.

8. A data processing method, applied to an operator of a neural network processing device, the operator being configured to perform a function calculation, and the data processing method comprising:
performing a first data processing on input data to generate processed data;
searching a first lookup table according to the processed data to obtain lookup data, wherein the first lookup table comprises mapping information between a plurality of first independent variables and a plurality of first dependent variables corresponding to the function calculation;
performing an interpolation on the lookup data to generate interpolated data; and
performing a second data processing on the interpolated data to generate output data.

9. The data processing method of claim 8, wherein the first lookup table is stored in a flash memory, the flash memory further stores a second lookup table, the second lookup table comprises mapping information between a plurality of second independent variables and a plurality of second dependent variables corresponding to the function calculation, a gap among the first independent variables is smaller than a gap among the second independent variables, and the operation of searching the first lookup table according to the processed data to obtain the lookup data comprises:
selectively searching one of the first lookup table and the second lookup table according to the processed data to obtain the lookup data.

10. The data processing method of claim 8, wherein the first lookup table is stored in a flash memory, the flash memory further stores a second lookup table, the second lookup table comprises mapping information between a plurality of second independent variables and a plurality of second dependent variables corresponding to the function calculation, the first independent variables are within a first numerical interval, the second independent variables are within a second numerical interval, the first numerical interval is different from the second numerical interval, and the operation of searching the first lookup table according to the processed data to obtain the lookup data comprises:
selectively searching one of the first lookup table and the second lookup table according to the processed data to obtain the lookup data.

11. The data processing method of claim 8, wherein the first data processing comprises performing a numerical format conversion on the input data.

12. The data processing method of claim 8, wherein the first data processing comprises performing a numerical equivalent conversion on the input data to obtain a first portion value and a second portion value, and the processed data comprises the first portion value and the second portion value.

13. The data processing method of claim 12, wherein the lookup data is obtained by searching the first lookup table according to the first portion value of the processed data, and the output data is generated by performing the second data processing on the interpolated data according to the second portion value of the processed data.

14. The data processing method of claim 12, wherein the first portion value obtained through the numerical equivalent conversion is within a searching range of the first lookup table.

15. A data processing device, applied to an operator of a neural network processing device, the operator being configured to perform a function calculation, and the data processing device comprising:
a front-end processing circuit configured to perform a first data processing on input data to generate processed data;
a lookup table circuit configured to search a first lookup table according to the processed data to obtain lookup data, wherein the first lookup table comprises mapping information between a plurality of first independent variables and a plurality of first dependent variables corresponding to the function calculation;
an interpolator circuit configured to perform an interpolation on the lookup data to obtain interpolated data; and
a back-end processing circuit configured to perform a second data processing on the interpolated data to generate output data.

16. The data processing device of claim 15, wherein the first lookup table is stored in a flash memory, the flash memory further stores a second lookup table, the second lookup table comprises mapping information between a plurality of second independent variables and a plurality of second dependent variables corresponding to the function calculation, a gap among the first independent variables is smaller than a gap among the second independent variables, and the lookup table circuit selectively searches one of the first lookup table and the second lookup table according to the processed data to obtain the lookup data.

17. The data processing device of claim 15, wherein the first lookup table is stored in a flash memory, the flash memory further stores a second lookup table, the second lookup table comprises mapping information between a plurality of second independent variables and a plurality of second dependent variables corresponding to the function calculation, the first independent variables are within a first numerical interval, the second independent variables are within a second numerical interval, the first numerical interval is different from the second numerical interval, and the lookup table circuit selectively searches one of the first lookup table and the second lookup table according to the processed data to obtain the lookup data.

18. The data processing device of claim 15, wherein the first data processing comprises performing a numerical format conversion on the input data.

19. The data processing device of claim 15, wherein the first data processing comprises performing a numerical equivalent conversion on the input data to obtain a first portion value and a second portion value, and the processed data comprises the first portion value and the second portion value.

20. The data processing device of claim 19, wherein the lookup table circuit searches the first lookup table according to the first portion value of the processed data, and the back-end processing circuit performs the second data processing on the interpolated data according to the second portion value of the processed data.
